(19) United States
(12) Patent Application Publication
(10) Pub. No.: US 2026/0099240 A1
(43) Pub. Date: Apr. 9, 2026

(54) INTERACTION METHOD, DEVICE AND COMPUTER-READABLE STORAGE MEDIUM

(71) Applicant: DOUYIN VISION CO., LTD., Shijingshan District, Beijing (CN)

(72) Inventor: Xinlong DING, Beijing (CN)

(21) Appl. No.: 19/104,111

(22) PCT Filed: Jun. 20, 2024
(86) PCT No.: PCT/CN2024/100291

§ 371 Date: Feb. 14, 2025

(51) Int. Cl. G06F 3/0483; G06F 40/40

(52) U.S. Cl. CPC G06F 3/0483; G06F 40/40

(57) ABSTRACT

The present disclosure relates to an interaction method, device and a computer-readable storage medium, and relates to the field of computer technology. The interaction method includes: pushing interactive multimedia content corresponding to a book to a user in response to the user browsing a designated chapter of the book, wherein the interactive multimedia content is generated according to the plot information of the book and a position of the designated chapter in the book; and interacting with the user according to interactive information input by the user based on the interactive multimedia content.

### TECHNICAL FIELD

The present disclosure relates to the field of computer technology, in particular to an interaction method, an interaction device, a computer-readable storage medium and a computer program product.

### BACKGROUND

With the development of computer technology, digital forms such as e-books and the like may be used to push works such as novels, scripts and the like to a user. In the related art, the user may browse and read e-books through various applications.

### SUMMARY

According to some embodiments of the present disclosure, there is provided an interaction method comprising: pushing interactive multimedia content corresponding to a book to a user in response to the user browsing a designated chapter of the book, wherein the interactive multimedia content is generated according to plot information of the book and a position of the designated chapter in the book; and interacting with the user according to interactive information input by the user based on the interactive multimedia content.

In some embodiments, the interactive multimedia content is generated according to whether the position of the designated chapter in the book is an intermediate chapter or a final chapter.

In some embodiments, the position of the designated chapter in the book is the intermediate chapter, and the interactive multimedia content is generated according to relevant information of a virtual object in the book.

In some embodiments, the position of the designated chapter in the book is the final chapter, and the interactive multimedia content is generated according to another book associated with the plot information of the book.

In some embodiment, the virtual object in the book comprises a character in the book, and the relevant information comprises a character attribute and/or plot information related to the character.

In some embodiments, a virtual object in the interactive multimedia content is selected from the virtual object in the book according to the relevant information, and the relevant information comprises popularity of the virtual object in the book and/or importance of the virtual object in the book in the plot information of the book.

In some embodiments, the interactive multimedia content is generated according to plot information of the other book and/or relevant information of a virtual object in the other book, and the virtual object in the other book is associated with the plot information of the book.

In some embodiments, the other book comprises an associated book of the book determined according to author information and/or book type information.

In some embodiments, the associated book comprises a new book published by an author of the book and/or a derivative book of the book, and the virtual object in the interactive multimedia content is determined according to plot information of the associated book, and the interactive multimedia content comprises plot information generated according to the virtual object in the interactive multimedia content.

In some embodiments, the interactive multimedia content comprises plot information generated according to a virtual object in the other book, and the virtual object in the other book has an associated relation with the virtual object in the book.

In some embodiments, the interactive multimedia content is generated according to prompt information, and the prompt information comprises structural information of the interactive multimedia content.

In some embodiments, the structural information comprises a number of chapters and a relationship between different chapters in the interactive multimedia content, and the interactive multimedia content comprises plot information corresponding to the chapters.

In some embodiments, the prompt information comprises instance information of the interactive multimedia content, and structural information of the instance information is same as the structural information of the interactive multimedia content.

In some embodiments, the interactive multimedia content comprises at least one task completion condition, the interacting with the user according to the interactive information input by the user based on the interactive multimedia content comprises: judging, by using a machine learning model, whether the user meets the at least one task completion condition, according to the interactive information.

In some embodiments, the interactive multimedia content comprises a plurality of chapters, each chapter of the plurality of chapters corresponds to the at least one task completion condition, the judging, by using the machine learning model, whether the user meets the at least one task completion condition, according to the interactive information comprises: judging, by using the machine learning model, whether the user meets the at least one task completion condition corresponding to current chapter, according to the interactive information input by the user based on the current chapter of the interactive multimedia content; and switching a progress of the interactive multimedia content to a next chapter of the interactive multimedia content, in response to the user meeting the at least one task completion condition corresponding to the current chapter.

In some embodiments, the judging, by using the machine learning model, whether the user meets the at least one task completion condition corresponding to the current chapter comprises: generating, by using the machine learning model, reply information corresponding to the interaction information, according to the interaction information and whether the user meeting the at least one task completion condition corresponding to the current chapter.

In some embodiments, the generating, by using the machine learning model, the reply information corresponding to the interaction information comprises: generating parameters corresponding to the interaction information, the parameters comprising a plurality of a character attribute of the user in the interactive multimedia content, plot information of the current chapter, or the at least one task completion condition corresponding to the current chapter; and generating, by using the machine learning model, the reply information according to the parameters.

In some embodiments, the interaction method further comprising: remaining the progress of the interactive multimedia content in the current chapter, in response to the user not meeting the at least one task completion condition corresponding to the current chapter.

In some embodiments, the interactive information comprises dialogue information of the user for a virtual object in the interactive multimedia content.

In some embodiments, the interactive multimedia content comprises background information, plot information and task information, and the task information comprises task content information and task completion conditions.

In some embodiments, the interactive multimedia content comprises multimedia content presented in an interactive manner with the user.

In some embodiments, the interactive multimedia content comprises plot information generated according to plot information of the designated chapter and/or plot development of a virtual object in the book in a subsequent chapter of the designated chapter.

According to some other embodiments of the present disclosure, there is provided an interaction device comprising: a push unit configured to push an interactive multimedia content corresponding to a book to a user in response to the user browsing a designated chapter of the book, wherein the interactive multimedia content is generated according to plot information of the book and a position of the designated chapter in the book; and an interaction unit configured to interact with the user according to interactive information input by the user based on the interactive multimedia content.

In some embodiments, the interactive multimedia content is generated according to whether the position of the designated chapter in the book is an intermediate chapter or a final chapter.

In some embodiments, the position of the designated chapter in the book is the intermediate chapter, and the interactive multimedia content is generated according to relevant information of a virtual object in the book.

In some embodiments, the position of the designated chapter in the book is the final chapter, and the interactive multimedia content is generated according to another book associated with the plot information of the book.

In some embodiment, the virtual object in the book comprises a character in the book, and the relevant information comprises a character attribute and/or plot information related to the character.

In some embodiments, a virtual object in the interactive multimedia content is selected from the virtual object in the book according to the relevant information, and the relevant information comprises popularity of the virtual object in the book and/or importance of the virtual object in the book in the plot information of the book.

In some embodiments, the interactive multimedia content is generated according to plot information of the other book and/or relevant information of a virtual object in the other book, and the virtual object in the other book is associated with the plot information of the book.

In some embodiments, the other book comprises an associated book of the book determined according to author information and/or book type information.

In some embodiments, the associated book comprises a new book published by an author of the book and/or a derivative book of the book, and the virtual object in the interactive multimedia content is determined according to plot information of the associated book, and the interactive multimedia content comprises plot information generated according to the virtual object in the interactive multimedia content.

In some embodiments, the interactive multimedia content comprises plot information generated according to a virtual object in the other book, and the virtual object in the other book has an associated relation with the virtual object in the book.

In some embodiments, the interactive multimedia content is generated according to prompt information, and the prompt information comprises structural information of the interactive multimedia content.

In some embodiments, the structural information comprises a number of chapters and a relationship between different chapters in the interactive multimedia content, and the interactive multimedia content comprises plot information corresponding to the chapters.

In some embodiments, the prompt information comprises instance information of the interactive multimedia content, and structural information of the instance information is same as the structural information of the interactive multimedia content.

In some embodiments, the interactive multimedia content comprises at least one task completion condition, and the interaction unit uses a machine learning model to judge whether the user meets the at least one task completion condition according to the interactive information.

In some embodiments, the interactive multimedia content comprises a plurality of chapters, each chapter of the plurality of chapters corresponds to the at least one task completion condition. According to the interactive information input by the user based on the current chapter of the interactive multimedia content, the interaction unit uses the machine learning model to judge whether the user meets the at least one task completion condition corresponding to current chapter, and in response to the user meeting the at least one task completion condition corresponding to the current chapter, switching a progress of the interactive multimedia content to a next chapter of the interactive multimedia content.

In some embodiments, the interaction unit generates, by using the machine learning model, reply information corresponding to the interaction information, according to the interaction information and whether the user meeting the at least one task completion condition corresponding to the current chapter.

In some embodiments, the interaction unit generates parameters corresponding to the interaction information, the parameters comprising a plurality of a character attribute of the user in the interactive multimedia content, plot information of the current chapter, or the at least one task completion condition corresponding to the current chapter; and generates the reply information by using the machine learning model, according to the parameters.

In some embodiments, the interaction unit remains the progress of the interactive multimedia content in the current chapter, in response to the user not meeting the at least one task completion condition corresponding to the current chapter.

In some embodiments, the interactive information comprises dialogue information of the user for a virtual object in the interactive multimedia content.

In some embodiments, the interactive multimedia content comprises background information, plot information and task information, and the task information comprises task content information and a task completion condition.

In some embodiments, the interactive multimedia content comprises multimedia content presented in an interactive manner with the user.

In some embodiments, the interactive multimedia content comprises plot information generated according to plot information of the designated chapter and/or plot development of a virtual object in the book in a subsequent chapter of the designated chapter.

According to some further embodiments of the present embodiment, there is provided a computer-readable storage medium, on which a computer program is stored, and the computer program, when executed by a processor, realizes an interaction method according to any of the above embodiments of the present disclosure.

According to some embodiments of the present disclosure, there is provided a computer program product, comprising an instruction that, when executed by a processor, causes the processor to implement an interaction method according to any one of the above embodiments of the present disclosure.

By means of the detailed description below of exemplary embodiments of the present disclosure with reference to the drawing attached thereto, further features and advantages of the present disclosure will become clearer.

### BRIEF DESCRIPTION OF THE DRAWINGS

The drawings attached thereto are intended to provide further understanding of the present disclosure, which drawings constitute part of the present application. Exemplary embodiments of the present disclosure and description thereof are intended to interpret the present disclosure, which do not constitute inappropriate limitation over the present disclosure. In the drawings:

FIG. 1 shows a flowchart of an interaction method according to some embodiments of the present disclosure;

FIG. 2 shows a schematic diagram of an interaction method according to some embodiments of the present disclosure;

FIG. 3 shows a flowchart of an interaction method according to some embodiments of the present disclosure;

FIG. 4 shows a block diagram of an interaction device according to some embodiments of the present disclosure;

FIG. 5 shows a block diagram of some other embodiments of an interaction device of the present disclosure;

FIG. 6 shows a block diagram of some further embodiments of an interaction device of the present disclosure.

### DETAILED DESCRIPTION

With reference to the figures of the embodiments of the present disclosure, a clear and complete description is given below for the technical solutions of the embodiments of the present disclosure. Obviously, the embodiments described below are only part of the embodiments, rather than all of the embodiments. The below description of at least one exemplary embodiment is actually only illustrative, and should by no means be taken as any restriction over the present disclosure and its application or use. All other embodiments that can be obtained by a person skilled in the art based on the embodiments of the present disclosure without any creative effort are included in the protection scope of the present disclosure.

Unless otherwise specified, elements and arrangement of steps relative to one another, numeric expressions and values recited in these embodiments do not restrict the scope of the present disclosure. Besides, it should be understood that, in order to facilitate illustration, dimensions of elements shown in the drawings are not given according to the actual scaling relation. For technology, process and apparatus already known by a person skilled in the related art, detailed discussion may not be given, but if appropriate, such technology, process and apparatus should be regarded as part of the patented specification. In any example shown or discussed here, any specific value should be interpreted only as being exemplary, rather than being restrictive. Thus, other examples of exemplary embodiments may have different values. It should be noted that, as like reference signs and letters in the below figures denote like elements, once an element is defined in a figure, it does not need to make further discussion for it in a subsequent figure.

As mentioned above, the inventors of the present disclosure have found that, the above related art has the following problem: the user can only browse the pushed book information such as novels, scripts and the like, but cannot interact with the book information, which results in a low information push efficiency. In view of this, the present disclosure provides an interactive technical solution, which may improve the information push efficiency.

In view of the above-described technical problem, the technical solution of the present disclosure may generate corresponding interactive multimedia content according to a designated chapter of a book browsed by the user, and interact with the user based on the interactive multimedia content. In this way, the interactive book allows the user to participate in the browsed book information, which improves the information push efficiency.

For example, the following embodiments may be used to realize the technical solution of the present disclosure.

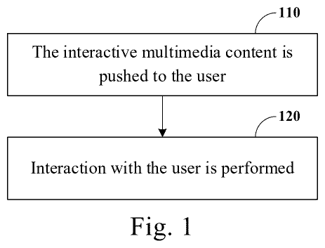

FIG. 1 shows a flowchart of an interaction method according to some embodiments of the present disclosure.

As shown in FIG. 1, in step 110, interactive multimedia content corresponding to the book is pushed to a user in response to the user browsing a designated chapter of a book. The interactive multimedia content may be generated according to plot information of the book and a position of the designated chapter in the book.

In step 120, interaction with the user is performed according to interactive information input by the user based on the interactive multimedia content.

In the above-described embodiments, the corresponding interactive multimedia content is generated according to the designated chapter of the book browsed by the user, and interaction with the user is performed based on the interactive multimedia content, so that the user may participate in the browsed book information, which improves information push efficiency.

In some embodiments, the book may comprise novels, scripts and the like, the interactive multimedia content may comprise multimedia content presented in an interactive manner with the user (for example, words, images, sounds, animations, videos and the like organized in a digital manner), and the interactive multimedia content may comprise interactive novels, interactive games, interactive episodes and the like.

The generation of the interactive multimedia content will be exemplarily described below by way of some embodiments.

In some embodiments, the interactive multimedia content may be generated according to the plot information of the book and the position of the designated chapter in the book. For example, the interactive multimedia content corresponding to an intermediate chapter or a final chapter may be generated according to whether the position of the designated chapter in the book is the intermediate chapter or the final chapter. For example, the book pushed to the user has an associated relationship with the generated interactive multimedia content in terms of plot information and/or a virtual object, etc. Different associated relationships may be configured according to whether the designated chapter is the intermediate chapter or the final chapter.

In some embodiments, in response to the position of the designated chapter in the book being the intermediate chapter, the interactive multimedia content is generated according to relevant information of a virtual object in the book. For example, the virtual object in the book may comprise a character present in the book. The relevant information of the virtual object comprises a character attribute and/or plot information related to the virtual object in the book.

For example, in response to the position of the designated chapter in a current book being the intermediate chapter, the derivative plot information of a character may be generated as the interactive multimedia content according to relevant plot information and a character attribute such as a character appearance, a character personality and the like of the character (which may be a person character or other character) present in the current book. Alternatively, in response to the position of the designated chapter in the book being the intermediate chapter, the derivative plot information of interaction between a plurality of characters may be generated as the interactive multimedia content according to relevant plot information of the plurality of characters present in the current book, a character attribute of each character such as a character appearance, a character personality and the like, and a relationship between the plurality of characters, etc.

In some embodiments, at least one character in the interactive multimedia content may be selected from a plurality of characters present in the current book according to relevant information such as popularity of a character and importance of a character in the plot. For example, a character of the greatest importance in the current chapter of the book may be selected as the character in the interactive multimedia content.

In some embodiments, the derivative plot information may be generated as the interactive multimedia content according to plot information of the designated chapter, plot development of a character in a subsequent chapter and the like.

For example, the character A present in a designated chapter is determined as the character in the interactive multimedia content, and plot development of the character A in the subsequent chapter comprises building a team with the character B and the character C to visit a designated place. The derivative plot information concerning that the character A makes acquaintance with the character B and the character C, and the character A, the character B and the character C discuss, understand or express an intention to visit the designated place may be generated as the interactive multimedia content.

In this way, an intermediate chapter of a current book is browsed by a user, the user may choose to enter the interactive multimedia content related to a character present in the current book for interaction, so that the user may participate in the plot of the current book and the information push efficiency is improved.

In some embodiments, in response to the position of the designated chapter in the book being a final chapter, the interactive multimedia content is generated according to another book associated with the plot information of the book. For example, another book associated with the current book may be determined according to book-related information such as author information and/or book type information corresponding to each book. The book type information may comprise subject types such as reasoning, romance, war and the like.

For example, another book with same author as the current book may be determined as an associated book of the current book. Another book with same author and same type as the current book may also be determined as the associated book of the current book.

In some embodiments, the interactive multimedia content is generated according to plot information of the other book and/or relevant information of a virtual object in the other book, and the virtual object in the other book is associated with the plot information of the book.

For example, in response to the position of the designated chapter in the current book being the final chapter, and a first character in the current book having an associated relationship with a second character in the other book, the derivative plot information of the current book may be generated as the interactive multimedia content according to the second character. The associated relationship may comprise, for example, that the first character and the second character belong to the same group, participate in the same event, know the same character and the like. For example, in response to the position of the designated chapter in the current book being the final chapter, and the current book having one of the same characters as the other book, the derivative plot information of the character may be generated as the interactive multimedia content according to relevant plot information of the character and a character attribute such as a character appearance and a character personality in the current book, as well as the relevant plot information of the character and a character attribute such as a character appearance and a character personality in the other book.

In some embodiments, the current book and the other book are the works of the same author, and the other book is a continuation of the current book in plot, and the interactive multimedia content may be generated according to the plot information of the other book to initiate the plot of the other book.

For example, in response to the author of the current book planning to publish an associated book such as a new book and/or a derivative book of the current book (for example, an side stories, bonus content and the like of the current book), the plot information of the associated book may be obtained. According to the plot information of the associated book, the character present in the interactive multimedia content is determined. According to the determined present character, the derivative plot information of the current book is generated as the interactive multimedia content.

In this way, in case where the user browses the final chapter of the current book, the user may choose to enter the interactive multimedia content corresponding to the other book associated for interaction, so as to push the other book to the user and allow the user to participate in the other book, which improves the information push efficiency.

In the above embodiments, it has been exemplarily described that the interactive multimedia content is generated according to the plot information and the user's browsing progress (that is, the designated chapter currently browsed by the user) of the current book. Next, by way of some embodiments, it will be exemplarily described that the interactive multimedia content is generated according to prompt information.

In some embodiments, the interactive multimedia content is generated according to the prompt information, and the prompt information comprises structural information of the interactive multimedia content. For example, a machine learning model may be used to generate the interactive multimedia content matched with the prompt information according to the input prompt information.

For example, the structural information comprises a number of chapters and a relationship between different chapters in the interactive multimedia content, and the interactive multimedia content comprises the plot information corresponding to the chapters. For example, it is possible to input the prompt information to a machine learning model, “Now I need you to write a creation of a script outline, and the structure of the outline is as follows: there are three chapters in total, wherein the first chapter, the second chapter and the third chapter are arranged sequentially”.

In some embodiments, the prompt information comprises instance information of the interactive multimedia content, and structural information of the instance information is the same as the structural information of the interactive multimedia content. For example, it is possible to input the prompt information to a machine learning model, “Now I need you to write a creation of a script outline, and the structure of the outline is as follows: there are three chapters in total, wherein the first chapter, the second chapter and the third chapter are arranged sequentially; the following is one example thereof: xxxxxx”.

In this way, the understanding of the creative intention by a machine learning model is used to allow the plot structure of the generated interactive multimedia content to conform to the desired structural information and enable the user to interact with the plot and the virtual object in the book to experience and participate in the plot of the book, which improves the information push efficiency.

Next, by way of some embodiments, interaction with the user based on the interactive multimedia content will be exemplarily described.

In some embodiments, the interactive multimedia content comprises background information, plot information and task information, wherein the task information comprises task content information and a task completion condition. For example, the interactive multimedia content comprises at least one task completion condition, and according to the interactive information, a machine learning model is used to judge whether the user meets the at least one task completion condition.

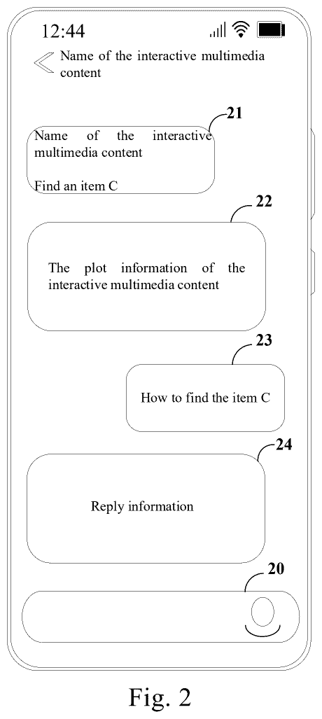

For example, by way of the embodiments in FIG. 2, interaction with the user may be performed based on the interactive multimedia content.

FIG. 2 shows a schematic diagram of an interaction method according to some embodiments of the present disclosure.

As shown in FIG. 2, in response to the user entering an interactive interface of an interactive book, at least one of a name of the interactive book, plot information of the interactive book and task content information for expressing the task completion condition may be displayed in the interactive interface. For example, a name of an interactive script and task content information “Find an item C” may be displayed in an agent dialog box 21. The plot information of the interactive script is displayed in an agent dialog box 22.

For example, after the task content information displayed in the agent dialog box 21 and the plot information of the interactive script displayed in the agent dialog box 22 are observed, the user may input the interactive information through an interactive control 20. The interactive information may be used to inquire prompt information of the task completion condition, for example, “how to find the item C”. The interactive information may be displayed in a user dialog box 23. Reply information may be generated according to the interactive information input by the user, and displayed in an agent dialog box 24 for the user to browse.

In the above-described embodiments, interaction with the user is performed based on the interactive multimedia content corresponding to the current book, so that the user may participate in the browsed current book, which improves the information push efficiency.

In some embodiments, the interactive multimedia content comprising a plurality of chapters may be generated according to the structural information, so as to generate different plot information, task completion conditions and the like for different chapters. For example, the interactive multimedia content comprises a plurality of chapters, each chapter of the plurality of chapters corresponds to at least one task completion condition. For example, the interactive multimedia content as shown in Table 1 may be generated.

TABLE 1

| | |
|---|---|
| Background | Character A profile: attribute information such |
| information | as character appearance, identity and |
| | personality |
| Plot information of | Interactive plot between the user and the |
| the first chapter | character A or the like |
| Task content | For example, the character A is persuaded to |
| information of the | stay or the like |
| first chapter | |
| Task completion | For example, if persuasion to stay is performed |
| conditions of the | after the user is angry, the character A agrees to |
| first chapter | stay. In other circumstances, the character A |
| | refuses with reasons. |
| Plot information of | Interactive plot between the user and the |
| the second chapter | character B or the like |
| Task content | For example, the character B is deceived |
| information of the | (explaining with proper reasons to convince |
| second chapter | the character B that the user has no relationship |
| | with the character A) or the like |
| Task completion | For example, if the reply of the user to the |
| conditions of the | character B comprises designated information, |
| second chapter | the character B is convinced. |

In some embodiments, according to the interactive information input by the user based on the current chapter of the interactive multimedia content, a machine learning model is used to judge whether the user meets the at least one task completion condition corresponding to the current chapter. In response to the user meeting the at least one task completion condition corresponding to the current chapter, the progress of the interactive multimedia content is switched to the next chapter of the interactive multimedia content. In response to the user not meeting the at least one task completion condition corresponding to the current chapter, the progress of the interactive multimedia content remains in the current chapter.

In some embodiments, the interactive information comprises dialogue information of the user for a virtual object in the interactive multimedia content. For example, if the user is in the first chapter of the interactive multimedia content, in response to the user initiating dialogue information to the character A so as to persuade the character A to stay, a machine learning model may be used to judge whether the dialogue information meets the task completion condition of persuading the character A to stay after the user is angry. In response to the dialogue information meeting the task completion condition, the progress of the interactive multimedia content is switched to the second chapter. In response to the dialogue information not meeting the task completion condition, the process of the interactive multimedia content remains in the first chapter.

For example, Table 2 shows the interaction process of the user based on the interactive multimedia content.

TABLE 2
Character A profile: name, gender, identity, personality . . .
Plot information of the first chapter: interactive
plot between the user and the character A or the like

| | |
|---|---|
| Character | Dialogue information |
| User | It is dangerous outside. |
| Character A | I know very well whether it is dangerous, and |
| | it's none of your business. |
| User | I am mad. Do not go out. |
| Character A | Okay. |

Plot information of the second chapter: interactive
plot between the user and the character B or the like

| | |
|---|---|
| User | I have no idea at all. |
| Character B | Are you sure not having been in contact with |
| | the character A? |
| User | I am pretty sure. |
| Character B | Okay. |

For example, based on the plot of the first chapter, the user initiates dialogue information “It is dangerous outside” to persuade the character A to stay, and a machine learning model may be used to judge that the dialogue information does not meet the task completion condition “Persuading the character A to stay after the user is angry”, and the character A refuses with reasons and reply “I know very well whether it is dangerous, and it's none of your business”. Based on the plot of the first chapter, the user continues to initiate dialogue information “I am mad. Do not go out” to persuade the character A to stay, and the machine learning model may be used to judge that the dialogue information meets the task completion condition “Persuading the character A to stay after the user is angry”, and the character A agrees to stay and reply “Okay”, and the progress of the interactive multimedia content is switched to the second chapter.

For example, based on the plot of the second chapter, the user initiates dialogue information “I have no idea at all” to the character B to convince the character B that the user has no relationship with the character A, and a machine learning model may be used to judge that the dialogue information does not meet the task completion condition “The reply of the user to the character B comprises designated information (for example, a definite tone or the like)”, and the character B is not convinced and replies “Are you sure not having been in contact with the character A?”. Based on the plot of the second chapter, the user continues to initiate dialogue information “I am pretty sure” to the character B to convince the character B that the user has no relationship with the character A, and the machine learning model may be used to judge that the dialogue information meets the task completion condition “The reply of the user to the character B comprises designated information”, and the character B is convinced and replies “Okay”, and the progress of the interactive multimedia content is switched to the next chapter.

In the above-described embodiments, each chapter of the interactive multimedia content has a task required to be completed by the user, and the user may initiate an interactive information by way of dialogue or the like to meet the task completion condition so as to enter the next chapter. In this way, the user may participate in the plot of the current book to improve the interactive effect, which improves the information push efficiency.

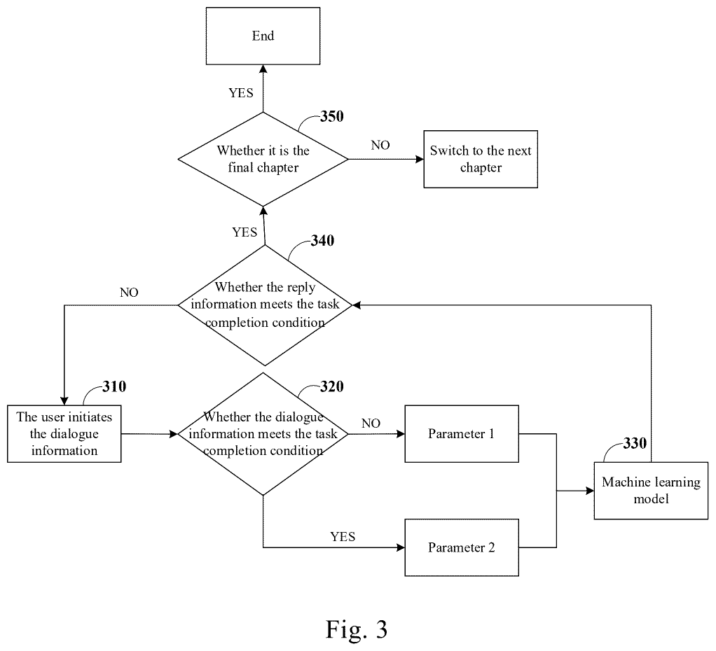

For example, by way of the embodiments in FIG. 3, interaction with the user may be performed based on the interactive multimedia content.

FIG. 3 shows a flowchart of an interaction method according to some embodiments of the present disclosure.

As shown in FIG. 3, in step 310, the user inputs the interactive information based on the plot information of the current chapter of the interactive multimedia content. For example, based on the plot information of the first chapter of the interactive multimedia content, the user initiates dialogue information “It is dangerous outside” to persuade the character A to stay.

In step 320, it is judged whether the interactive information meets the task completion condition of the current chapter, and parameters corresponding to the interactive information are generated according to a judgment result. For example, in response to the dialog information meeting the task completion condition of the first chapter, a parameter 1 is generated; and in response to the dialog information not meeting the task completion condition of the first chapter, a parameter 2 is generated.

In some embodiments, the parameters comprise a plurality of a character attribute of the user in the interactive multimedia content, plot information of the current chapter, or at least one task completion condition corresponding to the current chapter. For example, the parameters may comprise the character profile of the character A (for example, the attribute information such as name, gender, identity, personality, appearance and the like), the plot information of the first chapter, the task content information of the first chapter and the task completion condition of the first chapter.

For example, the parameter 1 and the parameter 2 may also comprise whether the dialogue information meets the task completion condition of the first chapter. For example, the parameter 1 is “first chapter-parameter 1—the task completion conditions of the first chapter are met”, and the parameter 2 is “first chapter-parameter 2—the task completion conditions of the first chapter are not met”.

In step 330, according to the generated parameters, the reply information is generated by using a machine learning model. For example, according to the interactive information and whether the user meets the at least one task completion condition corresponding to the current chapter, the machine learning model is used to generate the reply information corresponding to the interactive information.

For example, the reply information of the character A to the user may be generated according to the parameter 1 or the parameter 2. For example, in response to the parameter 1 meeting the task completion condition of the first chapter, the reply information of agreeing to stay is generated. In response to the parameter 2 not meeting the task completion condition of the first chapter, the reply information of refusing to stay with reasons is generated.

In step 340, it is judged whether the reply information meets the task completion condition. For example, in response to the reply information of agreeing to stay, it is determined that the task completion condition is met. In response to the reply information of refusing to stay with reasons, it is determined that the task completion condition is not met.

For example, in response to determining that the task completion condition is not met, returning to step 310 and the user initiates the dialogue information again. In response to determining that the task completion condition is met, performing step 350.

In step 350, it is judged whether the current chapter is the final chapter, and in response to the current chapter not being the final chapter, the progress of the interactive multimedia content is switched to the next chapter. In response to the current chapter being the final chapter, the interactive multimedia content is concluded. For example, if the current chapter is the first chapter, the progress of the interactive multimedia content may be switched to the second chapter. Based on the plot information, the task completion condition and the like of the second chapter, steps 310 to 350 are repeatedly performed.

In the above-described embodiments, the corresponding interactive multimedia content is generated according to a designated chapter of the book browsed by the user, and interaction with the user is performed based on the interactive multimedia content, so that the user may participate in the browsed book information, which improves information push efficiency.

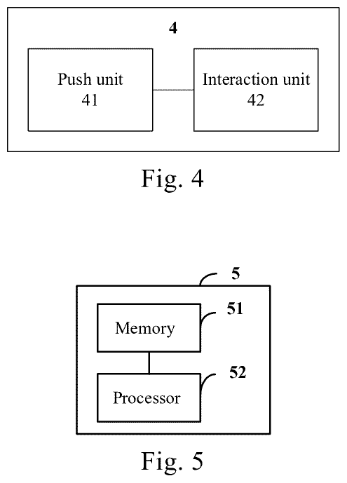

FIG. 4 shows a block diagram of an interaction device according to some embodiments of the present disclosure.

As shown in FIG. 4, the interaction device 4 comprises: a push unit 41 configured to push interactive multimedia content corresponding to a book to a user in response to the user browsing a designated chapter of the book, wherein the interactive multimedia content is generated according to plot information of the book and a position of the designated chapter in the book; and an interaction unit 42 configured to interact with the user according to interactive information input by the user based on the interactive multimedia content.

In some embodiments, the interactive multimedia content is generated according to whether the position of the designated chapter in the book is an intermediate chapter or a final chapter.

In some embodiments, the position of the designated chapter in the book is the intermediate chapter, and the interactive multimedia content is generated according to relevant information of a virtual object in the book.

In some embodiments, the position of the designated chapter in the book is the final chapter, and the interactive multimedia content is generated according to another book associated with the plot information of the book.

In some embodiment, the virtual object in the book comprises a character in the book, and the relevant information comprises a character attribute and/or plot information related to the character.

In some embodiments, a virtual object of the interactive multimedia content is selected from the virtual object in the book according to the relevant information, and the relevant information comprises popularity of the virtual object in the book and/or importance of the virtual object in the book in the plot information of the book.

In some embodiments, the interactive multimedia content is generated according to plot information of the other book and/or relevant information of a virtual object in other book, and the virtual object in the other book is associated with the plot information of the book.

In some embodiments, the other book comprises an associated book of the book determined according to author information and/or book type information.

In some embodiments, the associated book comprises a new book published by an author of the book and/or a derivative book of the book, and the virtual object in the interactive multimedia content is determined according to plot information of the associated book, and the interactive multimedia content comprises plot information generated according to the virtual object in the interactive multimedia content.

In some embodiments, the interactive multimedia content comprises plot information generated according to a virtual object in the other book, and the virtual object in the other book has an associated relation with the virtual object in the book.

In some embodiments, the interactive multimedia content is generated according to prompt information, and the prompt information comprises structural information of the interactive multimedia content.

In some embodiments, the structural information comprises a number of chapters and a relationship between different chapters in the interactive multimedia content, and the interactive multimedia content comprises plot information corresponding to the chapters.

In some embodiments, the prompt information comprises instance information of the interactive multimedia content, and structural information of the instance information is same as the structural information of the interactive multimedia content.

In some embodiments, the interactive multimedia content comprises at least one task completion condition, and the interaction unit 42 uses a machine learning model to judge whether the user meets the at least one task completion condition according to the interactive information.

In some embodiments, the interactive multimedia content comprises a plurality of chapters, each chapter of the plurality of chapters corresponds to the at least one task completion condition. According to the interaction information input by the user based on the current chapter of the interactive multimedia content, the interaction unit 42 uses the machine learning model to judge whether the user meets the at least one task completion condition corresponding to the current chapter, and in response to the user meeting the at least one task completion condition corresponding to the current chapter, a progress of the interactive multimedia content is switched to a next chapter of the interactive multimedia content.

In some embodiments, the interaction unit 42 generates reply information corresponding to the interaction information by using the machine learning model, according to the interaction information and whether the user meeting at least one task completion condition corresponding to the current chapter.

In some embodiments, the interaction unit 42 generates parameters corresponding to the interaction information, wherein the parameters comprise a plurality of a character attribute of the user in the interactive multimedia content, plot information of the current chapter, or the at least one task completion condition corresponding to the current chapter; and generates the reply information by using the machine learning model, according to the parameters.

In some embodiments, the interaction unit 42 remains the progress of the interactive multimedia content in the current chapter in response to the user not meeting the at least one task completion condition corresponding to the current chapter.

In some embodiments, the interactive information comprises dialogue information of the user for a virtual object in the interactive multimedia content.

In some embodiments, the interactive multimedia content comprises background information, plot information and task information, wherein the task information comprises task content information and a task completion condition.

In some embodiments, the interactive multimedia content comprises multimedia content presented in an interactive manner with the user.

In some embodiments, the interactive multimedia content comprises plot information generated according to plot information of the designated chapter and/or plot development of a virtual object in the book in a subsequent chapter of the designated chapter.

In the above-described embodiments, the corresponding interactive multimedia content is generated according to the designated chapter of the book browsed by the user, and interaction with the user is performed based on the interactive multimedia content, so that the user may participate in the browsed book information, which improves information push efficiency.

FIG. 5 shows a block diagram of an interaction device according to some other embodiments of the present disclosure.

As shown in FIG. 5, the interaction device 5 in this embodiment comprises: a memory 51; and a processor 52 coupled to the memory 51, wherein the processor 52 is configured to implement an interaction method according to any embodiment of the present disclosure based on an instruction stored in the memory 51.

Wherein, the memory 51 may comprise, for example, a system memory, a fixed non-volatile storage medium, or the like. The system memory stores, for example, an operation system, an application program, a boot loader, a database and other programs.

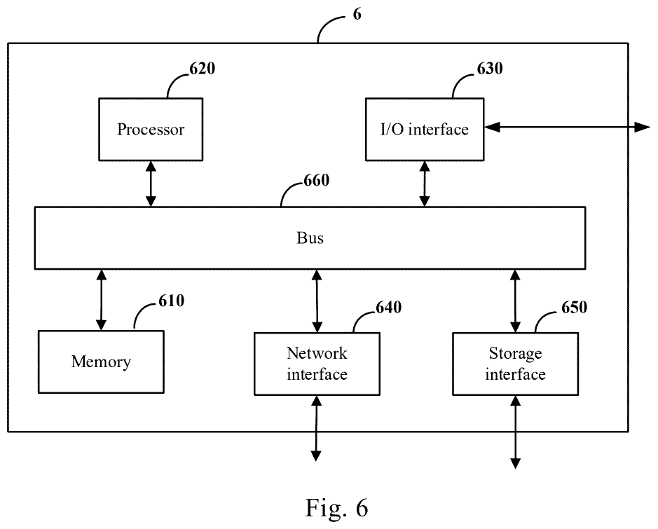

FIG. 6 shows a block diagram of an interaction device according to some further embodiments of the present disclosure.

As shown in FIG. 6, the interaction device 6 in this embodiment comprises: a memory 610; and a processor 620 coupled to the memory 610, wherein the processor 620 is configured to implement the method of any of the foregoing embodiments based on an instruction stored in the memory 610.

The memory 610 may comprise, for example, a system memory, a fixed non-volatile storage medium and the like. The system memory stores, for example, an operation system, an application program, a boot loader, and other programs.

The interaction device 6 may further comprise an I/O interface 630, a network interface 640, a storage interface 650 and the like. These interfaces 630, 640, 650 as well as the memory 610 and the processor 620 therebetween may be connected, for example, via a bus 660. Wherein, the I/O interface 630 provides a connection interface for input and output devices such as a display, a mouse, a keyboard, a touch screen, a microphone, a sound box and the like. The network interface 640 provides a connection interface for various networked devices. The storage interface 650 provides a connection interface for an external storage device such as a SD card, a USB flash disk and the like.

In the above-described embodiments, the corresponding interactive multimedia content is generated according to the designated chapter of the book browsed by the user, and interaction with the user is performed based on the interactive multimedia content, so that the user may participate in the browsed book information, which improves information push efficiency.

It should be understood by those skilled in the art that embodiments of the present disclosure can be provided as a method, a system, or a computer program product. Therefore, the present disclosure may take the form of an entirely hardware embodiment, an entirely software embodiment or an embodiment combining software and hardware aspects. Further, the present disclosure may take the form of a computer program product embodied on one or more computer-usable non-transitory storage media (comprising but not limited to disk storage, CD-ROM, optical storage, etc.) in which computer-usable program codes are embodied.

So far, the interaction method, interaction device, computer-readable storage medium and computer-readable program product according to the present disclosure have been described in detail. In order to avoid obscuring the concepts of the present disclosure, some details that are commonly known in the art have not been described. Those skilled in the art can fully understand how to implement the technical solutions disclosed here according to the above description.

The method and system of the present disclosure may be implemented in many ways. For example, the method and system of the present disclosure can be implemented by software, hardware, firmware or any combination of software, hardware and firmware. The above sequence of steps used in the method is only for illustration, and the steps of the method of the present disclosure are not limited to the sequence specifically described above, unless otherwise specified. Further, in some embodiments, the present disclosure can also be implemented as programs recorded in a recording medium, which comprise machine-readable instructions for implementing the method according to the present disclosure. Thus, the present disclosure also covers a recording medium storing a program for executing the method according to the present disclosure.

Although some specific embodiments of the present disclosure have been described in detail through examples, it should be understood by those skilled in the art that the above examples are only for illustration and are not intended to limit the scope of the present disclosure. It should be understood by those skilled in the art that the above embodiments can be modified without departing from the scope and spirit of the present disclosure. The scope of the present disclosure is defined by the appended claims.

1. An interaction method, comprising:
pushing interactive multimedia content corresponding to a book to a user in response to the user browsing a designated chapter of the book, wherein the interactive multimedia content is generated according to plot information of the book and a position of the designated chapter in the book; and
interacting with the user according to interactive information input by the user based on the interactive multimedia content.

2. The interaction method according to claim 1, wherein the interactive multimedia content is generated according to whether the position of the designated chapter in the book is an intermediate chapter or a final chapter.

3. The interaction method according to claim 2, wherein:
the position of the designated chapter in the book is the intermediate chapter, and the interactive multimedia content is generated according to relevant information of a virtual object in the book; or
the position of the designated chapter in the book is the final chapter, and the interactive multimedia content is generated according to another book associated with the plot information of the book.

4. The interaction method according to claim 3, wherein the virtual object in the book comprises a character in the book, and the relevant information comprises a character attribute and/or plot information related to the character.

5. The interaction method according to claim 3, wherein a virtual object in the interactive multimedia content is selected from the virtual object in the book according to the relevant information, and the relevant information comprises popularity of the virtual object in the book and/or importance of the virtual object in the book in the plot information of the book.

6. The interaction method according to claim 3, wherein the interactive multimedia content is generated according to plot information of the other book and/or relevant information of a virtual object in the other book, and the virtual object in the other book is associated with the plot information of the book.

7. The interaction method according to claim 5, wherein: the other book comprises an associated book of the book determined according to author information and/or book type information.

8. The interaction method according to claim 7, wherein: the associated book comprises a new book published by an author of the book and/or a derivative book of the book, and the virtual object in the interactive multimedia content is determined according to plot information of the associated book, and the interactive multimedia content comprises plot information generated according to the virtual object in the interactive multimedia content.

9. The interaction method according to claim 5, wherein the interactive multimedia content comprises plot information generated according to a virtual object in the other book, and the virtual object in the other book has an associated relation with the virtual object in the book.

10. The interaction method according to claim 1, wherein:
the interactive multimedia content is generated according to prompt information, and the prompt information comprises structural information of the interactive multimedia content; and/or
the interactive information comprises dialogue information of the user for a virtual object in the interactive multimedia content.

11. The interaction method according to claim 10, wherein:
the structural information comprises a number of chapters and a relationship between different chapters in the interactive multimedia content, and the interactive multimedia content comprises plot information corresponding to the chapters; and/or
the prompt information comprises instance information of the interactive multimedia content, and structural information of the instance information is same as the structural information of the interactive multimedia content.

12. (canceled)

13. The interaction method according to claim 1, wherein the interactive multimedia content comprises at least one task completion condition,
the interacting with the user according to the interactive information input by the user based on the interactive multimedia content comprises:
judging, by using a machine learning model, whether the user meets the at least one task completion condition, according to the interactive information.

14. The interaction method according to claim 13, wherein the interactive multimedia content comprises a plurality of chapters, each chapter of the plurality of chapters corresponds to the at least one task completion condition,
the judging, by using the machine learning model, whether the user meets the at least one task completion condition, according to the interactive information comprises:
judging, by using the machine learning model, whether the user meets the at least one task completion condition corresponding to current chapter, according to the interactive information input by the user based on the current chapter of the interactive multimedia content; and
switching a progress of the interactive multimedia content to a next chapter of the interactive multimedia content, in response to the user meeting the at least one task completion condition corresponding to the current chapter.

15. The interaction method according to claim 14, wherein the judging, by using the machine learning model, whether the user meets the at least one task completion condition corresponding to the current chapter comprises:
generating, by using the machine learning model, reply information corresponding to the interaction information, according to the interaction information and whether the user meeting the at least one task completion condition corresponding to the current chapter.

16. The interaction method according to claim 14, wherein the generating, by using the machine learning model, the reply information corresponding to the interaction information comprises:
generating parameters corresponding to the interaction information, the parameters comprising a plurality of a character attribute of the user in the interactive multimedia content, plot information of the current chapter, or the at least one task completion condition corresponding to the current chapter; and
generating, by using the machine learning model, the reply information according to the parameters.

17. The interaction method according to claim 14, further comprising:
remaining the progress of the interactive multimedia content in the current chapter, in response to the user not meeting the at least one task completion condition corresponding to the current chapter.

18. (canceled)

19. The interaction method according to claim 1, wherein;
the interactive multimedia content comprises background information, plot information and task information, and the task information comprises task content information and a task completion condition; and/or
the interactive multimedia content comprises multimedia content presented in an interactive manner with the user.

20. (canceled)

21. The interaction method according to claim 1, wherein the interactive multimedia content comprises plot information generated according to plot information of the designated chapter and/or plot development of a virtual object in the book in a subsequent chapter of the designated chapter.

22. (canceled)

23. An interaction device, comprising:
a memory; and
a processor coupled to the memory and configured to implement an interaction method, based on an instruction stored in the memory, comprising:
pushing interactive multimedia content corresponding to a book to a user in response to the user browsing a designated chapter of the book, wherein the interactive multimedia content is generated according to plot information of the book and a position of the designated chapter in the book; and
interacting with the user according to interactive information input by the user based on the interactive multimedia content.

24. A non-transitory computer readable storage medium, on which a computer program is stored, and the computer program, when executed by a processor, realizes an interaction method, comprising:
pushing interactive multimedia content corresponding to a book to a user in response to the user browsing a designated chapter of the book, wherein the interactive multimedia content is generated according to plot information of the book and a position of the designated chapter in the book; and
interacting with the user according to interactive information input by the user based on the interactive multimedia content.

25. (canceled)
